(19) United States
(12) Patent Application Publication
(10) Pub. No.: US 2004/0088896 A1
(43) Pub. Date: May 13, 2004

(54) Railing advertising - surface, system and method

(76) Inventor: Bruce M. Ruana, Gardnerville, NV (US)

Correspondence Address: SIERRA PATENT GROUP, LTD., P O BOX 6149, STATELINE, NV, 89449, US

(21) Appl. No.: 10/622,344

(22) Filed: Jul. 18, 2003

Related U.S. Application Data
(63) Continuation-in-part of application No. 09/877,409, filed on Jun. 7, 2001.

(51) Int. Cl. G09F 7/12

(52) U.S. Cl. 40/594; 40/316

(57) ABSTRACT

A folding advertising surface for affixing to a railing, grab bar or pole having an outer surface is disclosed. The folding advertising surface comprises a body having a first side and a second side opposite the first side. The first side has printed indicia forming a visual image. The folding advertising surface also comprises a releasable adhesive disposed on the second side of said body. The releasable adhesive is configured to adhere to the outer surface.

### CROSS REFERENCE TO RELATED APPLICATIONS

This application is a continuation-in-part of co-pending U.S. patent application Ser. No. 09/877,409, filed on Jun. 7, 2001.

### BACKGROUND

The present disclosure relates to a folding advertising surface, system and method of advertising and more particularly to a folding advertising surface, system and method of advertising on railings or other hand support systems and for use on poles or support beams.

Numerous types of media are used to advertise products and services in various settings. The type of advertising media used can vary depending upon the environment in which it is placed.

For example, point of purchase displays are often used to direct consumer attention to product offerings placed inside a store. Large billboards and other types of signage or displays along highways, on windows, on sides of vehicles, and the like are another advertising option and can be effective in attracting the attention of persons passing the display.

Floor graphics are a specific example of a point of purchase display. “Floor graphics” is an advertising industry term used to describe a substrate with graphics printed on the surface thereof, which is placed on the floor near a product display to direct a consumer's attention to a particular product display. Floor graphics are “billboards on the floor” that project an advertising campaign on the floor.

Various types of advertising media can also be effective to attract the attention of large numbers of people, for example, at a concert venue, a stadium, a race track, etc. As an example, billboards are often displayed at the above-mentioned places. Other examples include graphical displays on digital scoreboards, which are used in stadiums to attract the attention of a large number of people attending a particular event and billboards and/or digital graphics in moving vehicles such as buses and trains. While these methods are effective they can also be expensive and time consuming to program, display and change.

Hence there is a need for a folding advertising surface, system and method of advertising which can reach a large number of people while at the same time be cost effective for the advertiser and easy to display. There is also a need for a method of advertising which is easy to apply and can be removed quickly and replaced cost effectively.

### SUMMARY

The present invention is a folding advertising surface, system and method of advertising on a railing, feature, surface, grab-bar, other hand support system, pole or beam. The folding advertising surface is designed to provide cost effective releasably attachable advertising.

A folding advertising surface for affixing to a railing or pole having an outer surface is disclosed. The folding advertising surface comprises a body having a first side and a second side opposite the first side. The first side has printed indicia forming a visual image. The folding advertising surface also comprises a releasable adhesive disposed on the second side of said body. The releasable adhesive is configured to adhere to the outer surface.

An advertising system for presenting a visual image on a railing or pole having an outer surface is disclosed. The system comprises a body having a first side and a second side opposite the first side. The first side of the body has printed indicia forming the visual image. The second side is releasably adhered to the outer surface.

A method of applying a folding advertising surface on a railing or pole having an outer surface is disclosed. The method comprises providing the folding advertising surface. The folding advertising surface comprises a body having a first side and a second side opposite the first side. The body has a first set of alignment targets disposed on the first side and a releasable adhesive disposed on the second side of the body. The releasable adhesive is configured to adhere to the outer surface. The method further includes disposing a second set of alignment targets on the outer surface; aligning the first set of the alignment targets with the second set of the alignment targets; disposing the folding advertising surface on the outer surface; and folding the folding advertising surface around the outer surface.

The folding advertising surface, system and method of advertising will provide a cost effective advertising vehicle for advertisers who wish to provide point of sale advertising and who wish to reach large groups of consumers.

### BRIEF DESCRIPTION OF THE DRAWINGS

Referring now to the figures, wherein like elements are numbered alike:

FIG. 1A is an expanded side view of a folding advertising surface;

FIG. 1B is an expanded side view of another embodiment of a folding advertising surface;

FIG. 2 is an elevated perspective view of the folding advertising surface of FIG. 1A;

FIG. 3 is an expanded side view of another embodiment of a folding advertising surface;

FIG. 4 is an elevated perspective view of the folding advertising surface of FIG. 3;

FIG. 5 illustrates an advertising system for presenting a visual image using the folding advertising surface of FIG. 1A;

FIG. 6 illustrates an advertising system for presenting a visual image using the folding advertising surface of FIG. 3;

FIG. 7 illustrates a method of advertising using the folding surface of FIG. 1A; and

FIG. 8 illustrates a method of advertising using the folding surface of FIG. 2.

### DETAILED DESCRIPTION

Those of ordinary skill in the art will realize that the following description is illustrative only and not in any way limiting. Other embodiments will readily suggest themselves to such skilled persons.

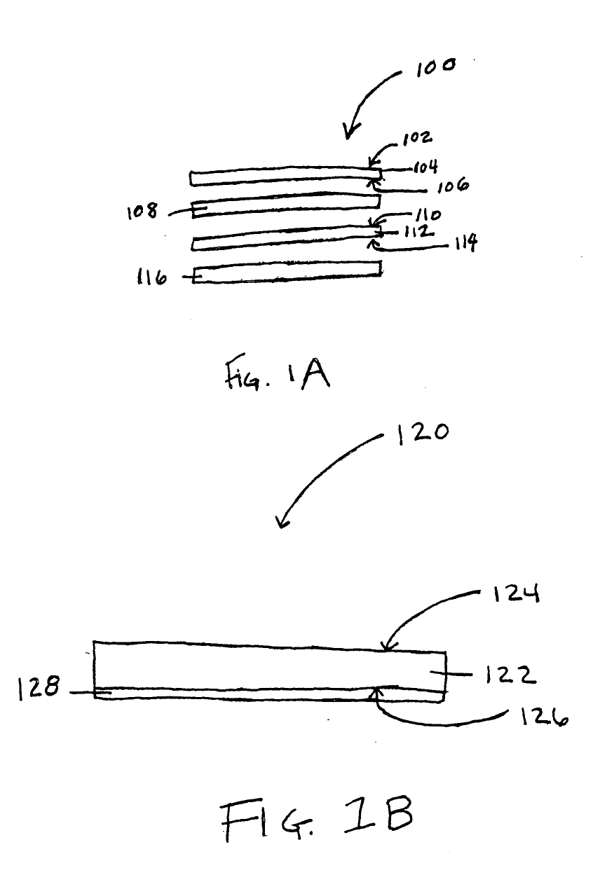

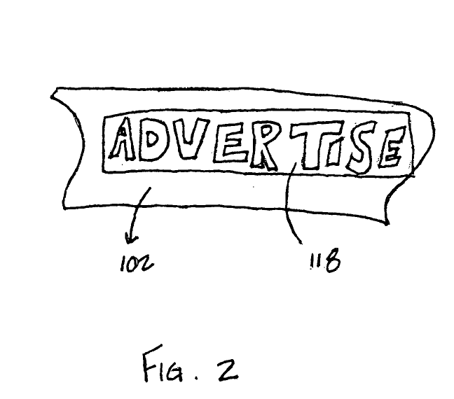

FIG. 1A illustrates an expanded view of a folding advertising surface 100 for use on a railing, hand support system, pole, support beam, or any other structure that can function as a support surface. Folding advertising surface 100 has a skin layer (or body) 104 and a four-way stretchable layer 112. Skin layer 104 can be formed from a variety of materials.

Examples of such materials include expanded vinyl, which is vinyl with a layer of foam that imparts a soft, textured feel; leather; plastic sheeting; plastic roll stock; any type of foam product; polyurethane; polyester; urethane; woven fabrics; rubber material; foil material; paper material; or any other material which could act as a covering to a hand support system. If skin layer 104 is formed from expanded vinyl, the vinyl surface may be smooth or textured. In addition, if a vinyl material is used, the vinyl may be supported or unsupported.

Skin layer 104 has a bottom surface 106 which is affixed to the top surface 110 of four-way stretchable material layer 112 by a permanent adhesive 108 that completely covers skin layer 104 from edge to edge. The permanent adhesive 108 can be any permanent adhesive known in the art, which will permanently bond skin layer 104 to four-way stretchable material layer 112. An example of such a permanent adhesive is FLEXCON® adhesive V-402. However, it will be clear to one skilled in the art that other similar suitable adhesives may be used.

Four-way stretchable material layer 112 has top surface 110 and a bottom surface 114, such that top surface 110 of four-way stretchable material layer 112 conforms to and is permanently affixed to bottom surface 106 of skin layer 104. Four-way stretchable material layer 112 may be comprised of any material that can simultaneously stretch in four directions, such as lycra, polyurethane, and a polyester material; an example is MYLAR®.

Bottom surface 114 of four-way stretchable material layer 112 is releasably attached to the railing or hand support system by a layer of releasable adhesive 116. Releasable adhesive 116 completely covers from edge to edge and is affixed to four-way stretchable material layer 112 and provides releasable adhesion to the railing or hand support system. Releasable adhesive 116 provides secure adhesion to the railing or hand support system but may be removed with a minimal amount of effort by peeling folding advertising surface 100 off the railing or hand support system. Any adhesive having the characteristics of being secured to the railing as well as being easily removed can be utilized. Any acrylic-based adhesive, rubber-based adhesive, or silicone-based adhesive can be utilized; a preferred example of a releasable adhesive is FLEXCON® V-58.

FIG. 1B illustrates an expanded view of a folding advertising surface 120 for use on a railing, hand support system, pole, support beam, or any other structure that can function as a support surface. Folding advertising surface 120 has a skin layer (or body) 122. Skin layer 122 has a first side 124 and a second side 126.

Skin layer 122 also has a lower surface, which is releasably attached to the railing or hand support system by a releasable adhesive 128. The releasable adhesive 128 is affixed to and completely covers skin layer from edge to edge and provides releasable adhesion to the railing or hand support system.

Releasable adhesive 128 provides secure adhesion to the railing or hand support system but may be removed with a minimal amount of effort by peeling grip off the railing or hand support system. Any adhesive having the characteristics of being secured to the railing as well as being easily removed can be utilized. Any acrylic-based adhesive, rubber-based adhesive, or silicone-based adhesive can be utilized; a preferred example of a releasable adhesive is FLEXCON® V-58.

FIG. 2 is an elevated perspective view of folding advertising surface 100. Folding advertising surface 120 could equally be utilized in FIG. 2. Skin layer 104 has top surface 102 and bottom surface 106. Top surface 102 of skin layer 104 has printed indicia that presents visual image 118. Visual image 118 can be created using any printing or graphic technique known in the art suitable for placing graphic designs on the folding material employed.

For example, sublimation printing utilizing heat and pressure to affix preprinted graphics produces a highly durable and accurate graphic. Many inks can be pretreated with ultraviolet (UV) inhibitors to prevent fading, an example of this type of ink is a sublimation ink. Luminescent inks can also be used to provide a glow in the dark environment. Reflective materials can be utilized to reflect light. Puff inks can be used to provide a textured surface. In addition, plastisol inks can be used in a heat transfer application for durable, long-lasting images. Wet ink printing can also be used as well as computer generated digital graphics, which are directly printed on various materials used as skin layer 104.

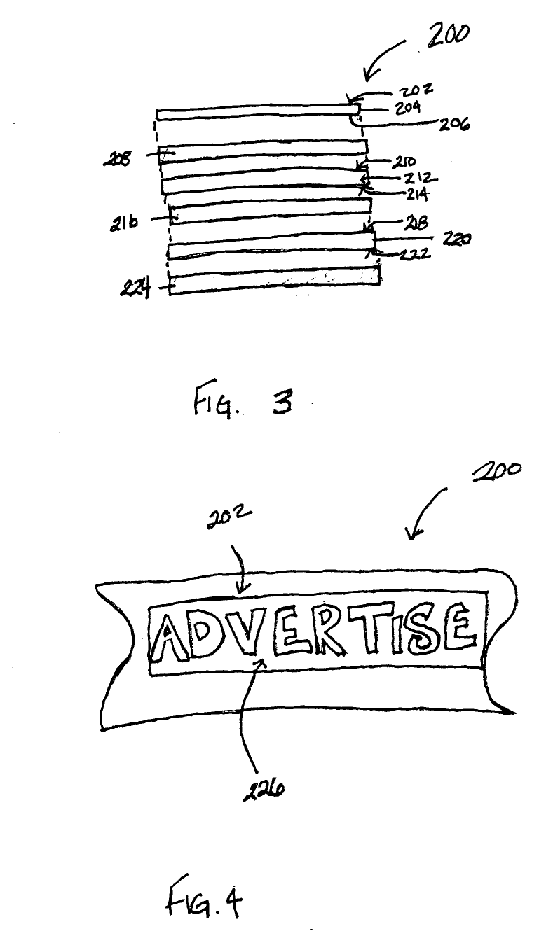

FIG. 3 illustrates folding advertising surface 200 for use on a railing, hand support system, pole or support beam or any other structure that can function as a support surface. Folding advertising surface 200 has a skin layer 204, a backing layer 212 and a four-way stretchable material layer 220. Skin layer 204 can be formed from a variety of materials.

Examples of such materials include, but are not limited to, expanded vinyl, which is vinyl with a layer of foam that imparts a soft, textured feel; leather; plastic sheeting; plastic roll stock; any type of foam product; polyurethane; polyester; urethane; woven fabrics; rubber material; foil material; paper material; or any other material which could act as a covering to a hand support system. If skin layer 204 is formed from expanded vinyl, the vinyl surface may be smooth or textured. In addition, if a vinyl material is used, the vinyl may be supported or unsupported.

Skin layer 204 has a bottom surface 206 which is affixed to top surface 210 of backing layer 212 by a permanent adhesive 208 which completely covers bottom surface 214 of backing layer 212 from edge to edge. The permanent adhesive 208 can be any permanent adhesive known in the art, which will permanently bond skin layer 204 to backing layer 212. An example of such a permanent adhesive is FLEXCON® adhesive V-402. However, it will be clear to one skilled in the art that other similar suitable adhesives may be used.

Backing layer 212 has a top surface 210 and a bottom surface 214, such that top surface 210 of backing layer 212 conforms to and is affixed to bottom surface 206 of skin layer 204. Backing layer 212 may be comprised of any material suitable for providing support including open cell foam, closed cell foam, felt, paper or rubber.

Bottom surface 214 of backing layer 212 is permanently adhered to the top surface 218 of four-way stretchable material layer 220. The permanent adhesive attaching bottom surface 214 of backing layer 212 to top surface 218 of four-way stretchable material layer 220 can be any permanent adhesive known in the art which will permanently bond the surfaces, an example of which is FLEXCON® V-402.

Four-way stretchable material layer 220 has the ability to stretch in all directions simultaneously, such as lycra, polyurethane, or a polyester material; an example is MYLAR®. Bottom surface 222 of four-way stretchable material layer 220 is releasably attached to the railing or hand support system by releasable adhesive 224. Releasable adhesive 224 is affixed to and completely covers four-way stretchable material layer 220 from edge to edge and provides releasable adhesion to the railing or hand support system.

Releasable adhesive 224 provides secure adhesion to the railing or hand support system but may be removed with a minimal amount of effort by peeling folding advertising surface 200 off the railing or hand support system. Any adhesive having the characteristics of being secured to the railing as well as being easily removed can be utilized. Any acrylic-based adhesive, rubber-based adhesive, or silicone-based adhesive can be utilized; a preferred example of a releasable adhesive is FLEXCON® V-58.

FIG. 4 is an elevated perspective view of folding advertising surface 200. Skin layer 204 has top surface 202 and bottom surface 206. Top surface 202 of skin layer 204 has printed indicia that presents visual image 226.

Visual image 226 can be created using any printing or graphic technique known in the art suitable for placing graphic designs on the folding material employed. For example, sublimation printing utilizing heat and pressure to affix preprinted graphics produces a highly durable and accurate graphic. Any inks utilized can be pretreated with UV inhibitors to prevent fading, an example of an ink is sublimation ink. Luminescent inks can also be used to provide a glow in the dark environment. Reflective materials can be utilized to reflect light. Puff inks can be used to provide a textured surface. In addition, plastisol inks can be used in a heat transfer application for durable, long-lasting images. Wet ink printing can also be used as well as computer generated digital graphics, which are directly printed on various materials used as skin layer 226.

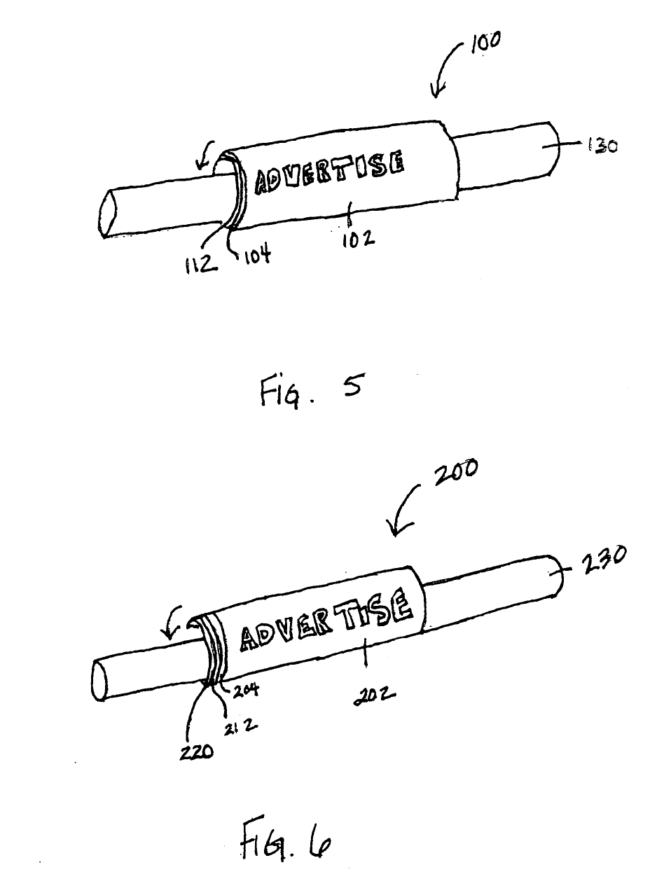

FIG. 5 discloses an advertising system for presenting a visual image on a railing. For convenience, the component parts of folding surface 100 are numbered as in FIG. 1A designating folding advertising surface 100. The system of the present invention can be utilized with any type of railing or hand support system 130.

Folding advertising surface 100 of the present invention can have a four-way stretchable material layer 116 with an inner and outer surface, skin layer 104 which has an inner layer and an out layer, the inner layer of the skin layer 104 is permanently adhered to the outer surface of the four-way stretchable material layer 116. Four-way stretchable material layer 116 is releasably adhered to railing 130. Skin layer 104 and four-way stretchable material layer 116 each have a width substantially similar to the circumference of railing 120, such that edges of skin layer 104 and the four-way stretchable material layer 116 can abut when folded around railing 130. It is preferable that the edges do not abut or overlap since this can create an environment for water and germs to infiltrate. The water can cause the materials to pull away from the outer surface of the railing, pole, or grab bar. The environment created can also become a breeding ground for germs.

Referring now to FIGS. 1 and 5, top surface 102 of skin layer 104 has printed indicia that presents visual image 118. Visual image 118 can be created using any printing or graphic technique known in the art suitable for placing graphic designs on the folding material employed. Visual image 118 is coupled to or disposed directly on skin layer 104.

FIG. 6 discloses yet another advertising system for presenting a visual image on a railing. For convenience, the component parts of folding surface 200 are numbered as in FIG. 3 designating folding advertising surface 200.

Folding advertising surface 200 of the present invention can have a four-way-stretchable material layer 220 with an inner and outer surface, backing layer 212 with an inner and outer surface, and skin layer 204 which has an inner surface and an outer surface, the inner surface of the skin layer 204 is permanently adhered to said outer surface of said backing layer 212. The inner surface of backing layer 212 is permanently adhered to four-way stretchable material layer 220. Four-way stretchable material layer 220 is releasably adhered to railing 230. Skin layer 204, backing layer 212 and four-way stretchable material layer 220 each have a width substantially similar to the circumference of railing 230, such that edges of said skin layer 204, backing layer 212 and said four-way stretchable material layer 220 can abut when folded around railing 230. As stated above, it is preferable that the edges do not abut or overlap since this can create an environment for water and germs to infiltrate. The water can cause the materials to pull away from the outer surface of the railing, pole, or grab bar. The environment created can also become a breeding ground for germs.

Referring now to FIGS. 3 and 6, top surface 202 of skin layer 204 has printed indicia that presents visual image 226. Visual image 226 can be created using any printing or graphic technique known in the art suitable for placing graphic designs on the folding material employed. Visual image 118 is coupled to or disposed directly on skin layer 204.

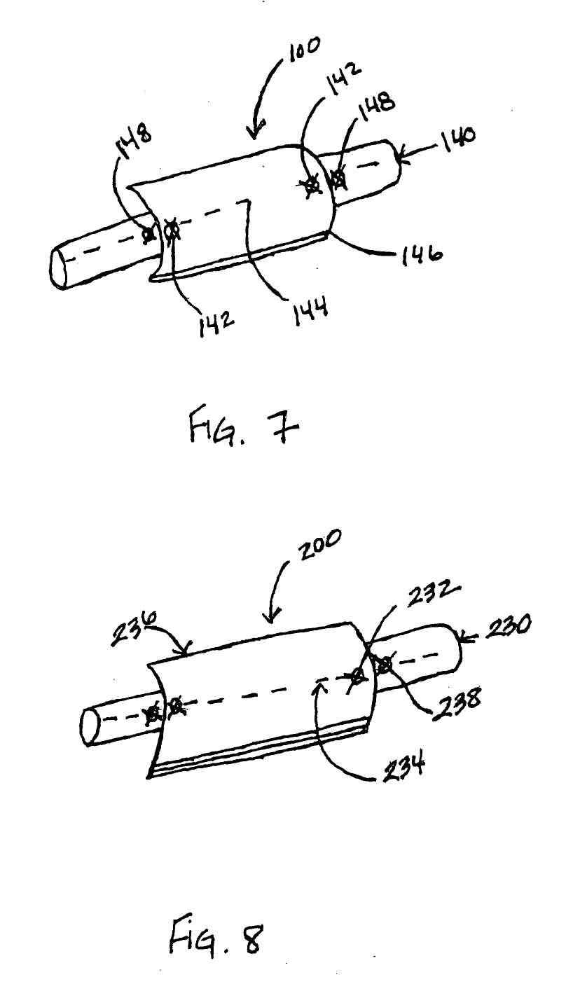

FIG. 7 discloses a method of advertising using folding around advertising surface 100 as illustrated in FIG. 1A. While alignment targets can be utilized, another embodiment contemplated does not utilize alignment targets. Folding around advertising surface 100 has an alignment target 142 along axis 144 parallel to lengthwise edge 146 of folding around advertising surface 100. Next, alignment target 148 is placed on railing 140. Next, folding surface 100 is placed on railing 140 so that the center lengthwise axis of folding surface 100 is centered on the axis parallel to the length of railing 140. Next, folding advertising surface 100 alignment targets 142 are aligned with railing 140 alignment targets 148. Finally, folding advertising surface 100 can have a width substantially similar to the circumference of railing 140 such that when folding advertising surface 100 is folded around railing 140 edges 146 of folding advertising surface 100 can abut. In some embodiments, the folding advertising surface 100 should substantially cover the circumference of the railing 140.

FIG. 8 discloses a method of advertising using folding around advertising surface 200. While alignment targets can be utilized, another embodiment contemplated does not utilize alignment targets. Folding around advertising surface 200 has alignment targets 232 along axis 234 parallel to lengthwise edge 236 of folding around advertising surface 200. Next, alignment targets 238 are placed on railing 230. Next, folding surface 200 is placed on railing 230 so that the center lengthwise axis of folding surface 200 is centered on the axis parallel to the length of railing 230. Next, folding advertising surface 200 alignment targets 232 are aligned with railing 230 alignment targets 238. Finally, folding advertising surface 200 can have a width substantially similar to the circumference of railing 230 such that when folding advertising surface 200 is folded around railing 230 edges 236 of folding advertising surface 200 abut. In some embodiments, the folding advertising surface 200 should substantially cover the circumference of the railing 230.

Considering that the folding advertising surface will be displace on railings, grab bars, and pole in relatively high traffic area for advertising purposes, the folding advertising surface is almost certain to become soiled or dirty. It is contemplated that the folding advertising surface can easily be cleaned using common maintenance products. It is also contemplated that the folding advertising surface can retain the cleaning products, or be made integral with the cleaning products, to provide the ability for ease in cleaning and further reduce soiling of the folding advertising surface.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A folding advertising surface for affixing to a railing, grab bar, or pole having an outer surface, the folding advertising surface comprising
a body having a first side and a second side opposite said first side, said first side having printed indicia forming a visual image; and
a releasable adhesive disposed on said second side of said body, said releasable adhesive configured to adhere to the outer surface.

2. The folding advertising surface of claim 1, wherein said body comprises a distance between said first side and said second side, said distance being variable.

3. The folding advertising surface of claim 1, wherein said body comprises a material selected from a group consisting of leather, plastic sheeting, plastic roll stock, foam material, polyurethane, polyester, woven fabric, urethane, rubber, paper and foil.

4. The folding advertising surface of claim 1, wherein said printed indicia is applied to said first side of said body by sublimation printing.

5. The folding advertising surface of claim 1, wherein said printed indicia is applied to said first side of said body by a heat pressure transfer process.

6. The folding advertising surface of claim 1, wherein said printed indicia is applied to said first side of said body by wet ink printing.

7. The folding advertising surface of claim 1, wherein said printed indicia is applied to said first side of said body by a digital graphics process.

8. The folding advertising surface of claim 1, wherein said printed indicia comprises a material selected from the group consisting of conventional inks, luminescent inks, reflective materials, puff inks, plastisol inks, ultraviolet inhibitors and preprinted graphics.

9. The folding advertising surface of claim 1, further comprising:
a backing layer adhered between said body and said releasable adhesive.

10. The folding advertising surface of claim 1, further comprising:
a stretchable material adhered between said body and said releasable adhesive.

11. The folding advertising surface of claim 1, wherein the folding advertising surface substantially covers the outer surface.

12. An advertising system for presenting a visual image on a railing, grab bar, or pole having an outer surface, the system comprising:
a body having a first side and a second side opposite said first side, said first side of said body having printed indicia forming the visual image, said second side releasably adhered to the outer surface.

13. The system of claim 12, wherein said body comprises a distance between said first side and said second side, said distance being variable.

14. The system of claim 12, wherein said body comprises a material selected from a group consisting of leather, plastic sheeting, plastic roll stock, foam material, polyurethane, polyester, woven fabric, urethane, rubber, paper, and foil.

15. The system of claim 12, wherein said stretchable material is polyester.

16. The system of claim 12, wherein said printed indicia is applied to said first side of said body by sublimation printing.

17. The system of claim 12, wherein said printed indicia is applied to said first side of said body by a heat pressure transfer process.

18. The system of claim 12, wherein said printed indicia is applied to said first side of said body by wet ink printing.

19. The system of claim 12, wherein said printed indicia is applied to said first side of said body by a digital graphics process.

20. The system of claim 12, wherein said printed indicia comprises a material selected from the group consisting of conventional inks, luminescent inks, reflective materials, puff inks, plastisol inks, ultraviolet inhibitors and preprinted graphics.

21. The system of claim 12, further comprising:
a backing layer adhered between said body and said releasable adhesive.

22. The system of claim 12, further comprising:
a stretchable material adhered between said body and said releasable adhesive.

23. The system of claim 12, wherein the folding advertising surface substantially covers the outer surface.

24. A method of applying a folding advertising surface on a railing, grab bar, or pole having an outer surface, the method comprising:
providing the folding advertising surface, the folding advertising surface comprising a body having a first side and a second side opposite said first side, said body having a first set of alignment targets disposed on said first side, and a releasable adhesive disposed on said second side of said body, said releasable adhesive configured to adhere to the outer surface;
disposing a second set of alignment targets on the outer surface;
aligning said first set of said alignment targets with said second set of said alignment targets;
disposing the folding advertising surface on the outer surface; and
folding the folding advertising surface around the outer surface.

25. The method of claim 24, wherein the folding advertising surface substantially covers the outer surface.

26. A method of applying a folding advertising surface on a railing, grab bar, or pole having an outer surface, the method comprising:
applying the folding advertising surface to said outer surface, the folding advertising surface comprising a body having a first side and a second side opposite said first side and a releasable adhesive disposed on said second side of said body, said releasable adhesive configured to adhere to the outer surface; and
folding the folding advertising surface around the outer surface.

27. The method of claim 26, wherein the folding advertising surface substantially covers the outer surface.
